(19) United States
(12) Patent Application Publication
(10) Pub. No.: US 2023/0083224 A1
(43) Pub. Date: Mar. 16, 2023

(54) SPIKE PARTICLES, SUPERFICIALLY POROUS SPIKE PARTICLES, CHROMATOGRAPHIC SEPARATION DEVICES, AND PROCESSES FOR FORMING SPIKE PARTICLES

(71) Applicant: RESTEK CORPORATION, Bellefonte, PA (US)

(72) Inventors: Hanjiang DONG, Bellefonte, PA (US); Diego A. LOPEZ, State College, PA (US)

(21) Appl. No.: 17/906,822

(22) PCT Filed: Mar. 19, 2021
(86) PCT No.: PCT/US2021/023229

§ 371 Date: Sep. 20, 2022

Related U.S. Application Data
(60) Provisional application No. 62/992,598, filed on Mar. 20, 2020.

(51) Int. Cl. B01J 20/28; B01J 20/286; B01J 20/32

(52) U.S. Cl. CPC B01J 20/28016; B01J 20/28011; B01J 20/28057; B01J 20/28069; B01J 20/28078; B01J 20/286; B01J 20/3293

(57) ABSTRACT

Spike particles are disclosed including a core and a plurality of spikes attached to and extending from a core surface. The core may be nonporous, superficially porous, or porous. The plurality of spikes may be nonporous or superficially porous. Superficially porous spike particles are disclosed including a porous spike particle shell disposed over a nonporous spike particle. A method for forming the spike particles is disclosed including mixing a dispersed aqueous phase having a plurality of core particles, a water emulsion drop stabilizer, and a catalyst with a continuous oil phase having an organic solvent, polyvinylpyrrolidone, and a silane precursor to form a water-in-oil emulsion system, which is reacted without stirring to form the plurality of chromatographic spike particles. A chromatographic separation device is disclosed including the spike particles, which are randomly packed in the chromatographic separation device and have an external porosity ranging from about 0.4 to about 0.9.

### RELATED APPLICATIONS

This application claims the benefit of and priority to U.S. Provisional Patent Application No. 62/992,598, filed Mar. 20, 2020, entitled “Chromatographic Spike Particles, Methods for Forming Chromatographic Spike Particles, and Separation Devices Having Chromatographic Spike Particles,” which is hereby incorporated by reference in its entirety.

### FIELD OF THE INVENTION

This application is directed to chromatographic spike particles, chromatographic separation devices, and processes for forming chromatographic spike particles. In particular, this application is directed to chromatographic spike particles, chromatographic superficially porous spike particles, chromatographic separation devices incorporating chromatographic spike particles and/or chromatographic superficially porous spike particles, and processes for forming chromatographic spike particles and chromatographic superficially porous spike particles.

### BACKGROUND OF THE INVENTION

Packing materials for separation devices, exemplified by chromatography columns, are generally classified into two types: spherical particles and monoliths. Both spherical particles and monoliths may be organic materials or inorganic materials (typified by silica). However, silica particles (more specifically, porous and superficially porous particles) are by far the most widely used packing materials.

In chromatography columns, separation efficiency and column permeability are two of the most important factors that determine their performance. Separation efficiency is a measure of the dispersion of a peak. While not being bound by theory, it is believed that structural uniformity (especially radial structure), smaller flow-through pores, and smaller particle diameters or monolith skeletons increase separation efficiency. Higher separation efficiency is desirable because it leads to narrower peaks and resolves more peaks during a given analysis time. Column permeability is inversely proportional to the flow resistance and is also related to the size of the flow-through pore. The flow resistance depends strongly on the external porosity of the packed bed, in proportion up to its fifth power. “External porosity” refers to the fraction of the volume that is not occupied by the solid component (either spherical particle or monolith). Higher external porosity and larger flow-through pore size increases column permeability. Column backpressure is inversely proportional to column permeability. Higher column permeability is desirable because it leads to lower backpressure and faster analysis time. There are many other benefits of low backpressure in chromatography columns, including, among others, less energy to push the fluid through the bed, low cost of the capital investment, easy operation of the instrument, low cost of instrument maintenance, less demand on the mechanical rigidity of the packed material, and long lifetime of the packed bed.

In columns packed with spherical particles, the particle diameter (dₚ) controls both column efficiency and permeability. As such, the diameter of the particles has been continuously shrinking in order to improve column separation efficiency and accelerate separation since the creation of high-performance liquid chromatography (HPLC) more than 50 years ago. On the other hand, the column permeability is proportional to dₚ², so column backpressure is inversely proportional to dₚ². This means that changing the particle diameter from 5 μm to 1 μm while keeping the size of the column same, will double the efficiency, but increase the backpressure by a factor of 25. Today, the most advanced UHPLC instrument can deliver up to 1,500 bar pressure and allow columns packed up to 1.5 μm particles to be operated at relatively high flow rates without exceeding the pressure limit. Furthermore, high backpressure can generate excessive frictional heating that may change the properties of fluid and analyte, leading to various negative effects on separation efficiency, selectivity, retention, and repeatability (Gritti et al., Anal. Chem., 81(2009), 3365-3384.). Accordingly, columns packed with sub 1 μm are not suitable for use in the state of the art UHPLC instruments, although they would otherwise be expected to further increase column efficiency.

Unlike columns packed with spherical particles where the external porosity is typically fixed at about 0.4, columns packed with monoliths may be stable even when their external porosity is increased to as high as about 0.9. Therefore, monolith-based columns have a much lower flow resistance and thus higher column permeability and lower backpressure than spherical particle-based columns. In addition, the size of the flow through channels (which partly sets the column permeability) and the size of solid skeletons (which partly determines the column efficiency) of monolith-based columns are independently adjustable. Accordingly, monolith-based columns, in principle, provide a better combination of column performance, potentially offering higher efficiency, and higher permeability. However, while otherwise promising, monolith-based columns are plagued by an inherent radial structural inhomogeneity, leading to a low column efficiency (Hlushkou et. al., J. Chromatogr. A, 1303 (2013), 28-38). It has also been found that structural heterogeneity is magnified as the sizes of flow-through pore and skeleton become smaller (Broeckhoven and Desmet, Anal. Chem. 93 (2021), 257-272.) Therefore, it is difficult to further improve separation efficiency of monolith-based columns at the current level, which is lower than that of columns packed with sub 2 μm porous particles and sub 2 and 3 μm superficially porous particles. Other drawbacks of monolith-based columns include: (1) surface modification must be separately manufactured for each column (a significant concern relating to cost and reproducibility of the product); (2) column separation modes and dimensions are very limited; and (3) the maximum operational pressure is very low, less than 400 bar (typically 200 bar). Therefore, monolith-based columns are commercially competitive only in the niche capillary column market, and have, thus far, failed to live up to their potential in the fast separation column market, which is dominated by columns packed with sub 2 μm porous spherical particles and sub 2 and 3 μm superficially porous spherical particles (with porous spherical particle and superficially porous spherical particle technologies still evolving).

As suggested by the above descriptions, there are several drawbacks of currently packing materials. The separation efficiency of columns packed with spherical particles appear to have reached or nearly reached their limit due to the low permeability of smaller spherical particles, preventing columns packed with particles smaller than 1.5 μm to operate at high flow and/or optimal rates under the current state of the art of UHPLC instruments. A recent study showed that the potential speed gain (efficiency related) from the current 1,500 bar to 3,000 bar operational pressure is relatively small. On top of that, there are many issues associated with such a high pressure such as frictional heating, mechanical stability of packing material, reliable instrumental hardware (pump, injector, detector) and column hardware, and instrumental hardware design (to reduce extra column band dispersion) (Broeckhoven and Desmet, Anal. Chem. 92 (2020), 554-560). On the other hand, while monolith-based columns have high permeability, this advantage is mitigated by their low operational backpressure (typically 200 bar for analytical columns). More importantly, it is difficult to further improve their efficiency due to fundamental limitations including radial structural heterogeneity as well as increased variations of flow-through pores and solid skeletons when these features are downsized. Another limitation is that high efficiency and high permeability are inherently incompatible, which is present in both spherical particle-based columns and monolith-based columns (Broeckhoven and Desmet, Anal. Chem. 93 (2021), 257-272.).

Therefore, it is desirable to develop alternative packing materials to have a better compromise between columns separation efficiency and permeability that can overcome the above problems.

Datskos et al. was among the first to report the preparation of spike particles in a water-in-oil emulsion system under basic conditions (Datskos et al., Angew. Chem. Int. Ed., 54 (2015), 9011-9015). They demonstrated that rod-like spikes could form on hydrophilic spherical core particles such as silica and titania. Spikes were later formed on substrates with different compositions and shapes under similar conditions (Kim et al., J. Am. Chem. Soc., 140 (2018), 9230-9235; Li et al., Angew. Che. 130 (2018), 383-3838; Zhao et al., Scientific Reports, 9 (2019), 8591).

One drawback of Datsko's method is that sodium citrate was used to stabilize the water emulsion droplets and subsequently sodium ions were unavoidably present in the spikes. It is well known that trace metal ion impurities in chromatographic silica particles (the so-called type A silica) may increase the acidity of surface silanols, causing a change of retention time, broadening and tailing of the band, and lowering sample recovery of basic compounds and biomolecules (Nawrocki and Buszewski, J. Chromatogr., 449 (1988), 1-24; U.S. Pat. No. 5,256,386.). In addition, chromatographic silica particles, regardless of what methods are used to prepare them, often involve one or more calcination or sintering step to remove organic additives and increase their mechanical stability. For use in UHPLC columns, silica particles may have to be sintered at about 950° C. for the silica particles to have sufficient mechanically stability under packing pressures often exceeding 1,500 bar. However, silica particles with a sufficiently high sodium ion content are unable to be sintered at such a high temperature due to their low melting point. As such, type A silica is not regarded as being a suitable material for chromatographic packing (Majors, LC GC North America, 33 (2015), 818-840). Another drawback of Datsko's method is that only nonporous spike particles were contemplated.

### BRIEF DESCRIPTION OF THE INVENTION

In one exemplary embodiment, a spike particle includes a core having an average core width and a core surface, and a plurality of spikes attached to the core surface, the plurality of spikes extending an average spike length from the core surface and having an average spike width measured orthogonal to the average spike length. The spike particle is a chromatographic particle having not more than 100 ppm sodium ions. The core includes a porosity selected from the group consisting of nonporous, superficially porous, porous, and combinations thereof. The plurality of spikes include a porosity selected from the group consisting of nonporous, superficially porous, and combinations thereof.

In another exemplary embodiment, a superficially porous spike particle includes a core having an average core width and a core surface, the core being non-porous, a plurality of spikes attached to the core surface, the plurality of spikes being nonporous and extending an average spike length from the core surface and having an average spike width measured orthogonal to the average spike length, and a porous spike particle shell disposed on the core and the plurality of spikes, wherein the spike particle is a chromatographic particle having not more than 100 ppm sodium ions.

In another exemplary embodiment, a chromatographic separation device includes a plurality of spike particles. Each of the plurality of spike particles includes a core having an average core width and a core surface, and a plurality of spikes attached to the core surface, the plurality of spikes extending an average spike length from the core surface and having an average spike width measured orthogonal to the average spike length. Each of the plurality of spike particles is a chromatographic particle. The core includes a porosity selected from the group consisting of nonporous, superficially porous, porous, and combinations thereof. The plurality of spikes include a porosity selected from the group consisting of nonporous, superficially porous, and combinations thereof. The plurality of spike particles are randomly packed in the chromatographic separation device. The plurality of spike particles as randomly packed have an external porosity ranging from about 0.4 to about 0.9. The chromatographic separation device has increased fluid permeability relative to a comparative chromatographic separation device having a plurality of otherwise identical spherical particles lacking the plurality of spikes in lieu of the plurality of spike particles.

In another exemplary embodiment, a process for forming a plurality of spike particles includes mixing a continuous oil phase and a dispersed aqueous phase to form a water-in-oil emulsion system. The continuous oil phase includes an organic solvent, polyvinylpyrrolidone, and a silane precursor. The dispersed aqueous phase includes a plurality of core particles, a water emulsion drop stabilizer, and a catalyst. The water-in-oil emulsion system is reacted without stirring to form the plurality of spike particles, and the plurality of spike particles are separated from the water-in-oil emulsion system. Each of the plurality of spike particles includes a core having an average core width and a core surface, and a plurality of spikes attached to the core surface, the plurality of spikes extending an average spike length from the core surface and having an average spike width measured orthogonal to the average spike length.

### BRIEF DESCRIPTION OF THE DRAWINGS

FIG. 1 is a schematic view of an example embodiment of a spike particle, according to an embodiment of the present disclosure.

FIG. 2 presents SEM images of various spike particles illustrating control of the length, number, and width of the spikes, according to embodiments of the present disclosure.

FIG. 3(a) is schematic representation of a spike particle having a nonporous core and nonporous spikes, according to an embodiment of the present disclosure.

FIG. 3(b) is schematic representation of a spike particle having a superficially porous core and nonporous spikes, wherein the superficially porous core has a nonporous central region and a porous shell disposed thereon with randomly oriented pores, according to an embodiment of the present disclosure.

FIG. 3(c) is schematic representation of a spike particle having a superficially porous core and nonporous spikes, wherein the superficially porous core has a nonporous central region and a porous shell disposed thereon with radially oriented pores, according to an embodiment of the present disclosure.

FIG. 3(d) is schematic representation of a spike particle having a porous core with randomly oriented pores and nonporous spikes, according to an embodiment of the present disclosure.

FIG. 3(e) is schematic representation of a superficially porous spike particle with radially oriented pores, according to an embodiment of the present disclosure.

FIG. 3(f) is schematic representation of a superficially porous spike particle with randomly oriented pores, according to an embodiment of the present disclosure.

FIG. 4 presents SEM images of spike particles prepared according to the processes in Examples 1-4, according to embodiments of the present disclosure. The scale bar is 5 μm, applicable to all images.

FIG. 5 is a schematic representation of randomly packed spherical particles, according to a prior art embodiment.

FIG. 6(a) is a schematic representation of randomly packed spiked particles with spike lengths about one-third of the width of the core, according to an embodiment of the present disclosure.

FIG. 6(b) is a schematic representation of randomly packed spiked particles with spike lengths about equal to the width of the core, according to an embodiment of the present disclosure.

FIG. 7 shows column back pressure versus flow rate data obtained with columns (2.1×50 mm) packed with spike particles prepared according to the process of Example 5 as compared to spherical particles having a width equal to the average core width of the spike particles, accompanied by an SEM image of the spike particles.

FIG. 8 compares chromatographic data obtained with columns packed with spike particles prepared according to the process in Example 6 as compared to columns packed with porous spherical particles having widths of 3 μm and 5 μm. Panel A is back pressure versus mobile phase flow rate and panel B is height equivalent to a theoretical plate versus mobile phase velocity. Panel C is an SEM image of the spike particles.

Wherever possible, the same reference numbers will be used throughout the drawings to represent the same parts.

### DETAILED DESCRIPTION OF THE INVENTION

Disclosed herein are chromatographic spike particles, chromatographic separation devices, and processes for forming chromatographic spike particles. Spike particles have an inner core particle and a plurality of outer rod-like spikes, which are attached on the surface of the inner core particle. There are several advantages associated with spike particles as packing materials. Column permeability is inversely proportional to the flow resistance, which depends strongly on the external porosity, in proportion up to its fifth power. In columns packed with spherical particles, each spherical particle must contact a certain number of other spherical particles to produce a stable packed bed, leading to their external porosity typically close to 0.4, a value that is independent of the particle diameter. Increasing external porosity requires a proportional increase of defects, causing the bed to become unstable and drastically reducing the column efficiency (Schure and Maier, J. Chromatogr. A, 1126 (2006), 58-69). In contrast, the extended outer spikes of spike particles offer more pathways to contact each other including, spike-spike, spike-core, and core-core. The spike-spike and spike-core touching keep the core particles apart and increase the external porosity of the packed beds. In addition, each spike may contact more than one other spike and there are multiple spikes on each spike particle. Therefore, the average contact number of each spike particle in columns packed with spike particles is likely much higher than that in columns packed with spherical particles. The increased contact number allows the packed bed to remain stable even though its external porosity is larger than 0.4. Therefore, columns packed with spike particles have a higher external porosity, leading to a lower flow resistance and higher column permeability than columns packed with spherical particles.

The number and/or length of spikes on spike particles may be easily adjusted. This provides a convenient approach to adjusting the external porosity of the packed bed by simply changing the number and/or length of spikes with or without changing the core size. In general, the higher number and/or the longer length of spikes, the higher the external porosity and the higher the bed permeability are.

Therefore, columns packed with spike particles have a higher external porosity than columns packed with spherical particles. In addition, the packed spike particles have an adjustable external porosity while the latter have a fixed external porosity at approximately 0.4. Spike particles and monoliths are similar in terms of these properties. However, unlike the skeletons of monoliths, spike particles are rarely agglomerated into large chunks. Even if agglomerates do form, they may be separated by known methods. In addition, the slurry method used to pack spherical particles is compatible with spike particles, thus avoiding the radial structural heterogeneity present in monolith-based columns. Accordingly, spike particles overcome the drawback of low permeability of spherical particles and the low efficiency of monoliths. It may be possible to develop columns packed with spike particles with sub 1 μm cores having a better efficiency than columns packed with sub 2 μm spherical particles such that the former may still be operated with current UHPLC instruments. Likewise, it may be possible to develop columns packed with spike particles having a sub 2 μm cores with similar efficiency compared to columns packed sub 2 μm spherical particles such that the former may still be operated with current HPLC instruments.

A further advantage of spike particles is that usage of spike particles may relax, to some degree, the fundamental comprise between column efficiency and permeability presented in both spherical particle-based columns and monolith-based columns. Columns with a high external porosity (high permeability) have large flow-through pores. While not being bound by theory, it is believed that large flow-through pores induce large mobile zone mass transfer as well as eddy dispersion, inherently reducing column efficiency. There are some differences in the flow-through pores in columns packed with spike particles compared to those in columns packed with spherical particles and monoliths. First, the contact variations of spike particle change the shape of the flow-through pores. It is, however, not clear how this will affect the column efficiency and permeability. Second, in columns packed with spike particles, a flow-through pore coexists with a certain number of spikes in the same flow domain. A long spike may even pass through more than one flow-through pore. The presence of spikes in the flow-through pores may effectively reduce a large flow-through pore into several smaller flow-through pores, thus reducing the mobile zone diffusion distance of analytes. These spikes may provide radial mixing, reducing analyte diffusion in the flow-through pore. Therefore, even though columns packed with spike particles have a relatively high external porosity (high permeability), their feature sizes of the solid zone (cores and spikes) and mobile zone (effective flow-through pores) may be relatively small. Accordingly, columns packed with spike particles may have a relatively loose relationship between efficiency and permeability compared to columns packed with spherical particles or monoliths.

Accordingly, this invention provides spike particles, wherein said spike particles comprise of an inner core particle and a plurality of outer spikes that are attached on the surface of the inner core particle. This invention also provides spike particles that can be used as new packing materials to substantially increase and readily adjust the flow permeability of separation devices exemplified in chromatographic columns. This invention also provides improved methods to make metal ion-free thermally and mechanically stable spike particles.

Another aspect of this invention is to provide a separation device having a stationary phase comprising a plurality of spike particles as described herein, where said the separation device has improved and readily adjustable device permeability.

Another aspect of this invention is to provide a chromatography column having a stationary phase comprising a plurality of spike particles as described herein, where said chromatography column has an improved and readily adjustable device permeability.

A further aspect of this invention provides process of making metal ion-free, thermally, and mechanically stable spike particles in a water-in-oil emulsion system under basic conditions and subsequently separating the spike particles from the emulsion mixture, calcinating the spike particles up to 850° C. to removal organic residual materials. Additional process steps may include one or more than one of the following steps: coating the spike particles with a porous layer; sintering them up to 950° C. to increase their mechanical rigidity; rehydrolyzing them to maximize the number of Si—OH groups on their surface; and modifying them to have a functional surface.

As used herein, “about” indicates a variance of up to 10% of the value so modified, and specifically includes the absolute value as well, such that “about 2” discloses both a range from 1.8 to 2.2 as well as 2.

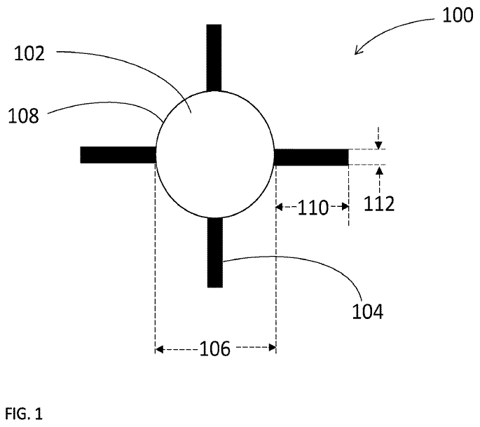

Referring generally to FIGS. 1-4, in one embodiment a spike particle 100 includes a core 102 and a plurality of spikes 104. The spike particle 100 is a chromatographic particle. The core 102 has an average core width 106 and a core surface 108. The plurality of spikes 104 are attached to the core surface 108 and extend an average spike length 110 from the core surface 108. The plurality of spike have an average spike width 112 measured orthogonal to the average spike length 110. The core 102 may be nonporous, superficially porous, porous, or combinations thereof. The plurality of spikes 104 may be nonporous, superficially porous, or combinations thereof

For cores 102 which are spherical or spheroidal, the “average core width” 106 is synonymous with core diameter, whereas for cores 102 which have a conformation other than spherical or spheroidal, the “average core width” 106 is the average of all of the widths measured from opposing surfaces of the core 102. For spikes 104 which have a circular cross-section orthogonal to the average spike length 110, the “average spike width” 112 is synonymous with spike diameter, averaged along the average spike length 110, whereas for spikes 104 which have a cross-section orthogonal to the average spike length 110 other than circular, the “average spike width” 112 is the average of all of the widths measured from opposing surfaces of the spike 104 along the average spike length 110.

As used herein, “nonporous” indicates a lack of any material degree of porosity, permitting only incidental defects in structure which do not affect material characteristics; “porous” indicates that a continuously porous structure is present, although the degree of porosity, size of pores 200, and distribution of pores 200 need not be homogenous; and “superficially porous” indicates the presence of a porous shell 206 or porous spike particle shell 502 surrounding a nonporous article such as, but not limited to, a nonporous central region 204 or nonporous spike particle 100. The pores 200 may be radially oriented or randomly oriented. Exemplary nonporous, superficially porous, or porous particles that may be used as the core particle 102 are described in U.S. Pat. No. 4,775,520, U.S. Patent Application Publication No. 2007/0189944 A1, and U.S. Pat. No. 5,256,386, respectively, the contents of which are incorporated herein by reference in their entirety. The core particle 102 may include two or more compositions, shapes, and porosities, depending on its particular application. Exemplary particles that have more than one composition or porosity that may be used as a core particle 102 are described in U.S. Pat. No. 8,778,453 and U.S. Pat. No. 10,434,496, respectively, the contents of which are incorporated herein by reference in their entirety.

All combinations of the core 102 being nonporous, superficially porous, porous, or combinations thereof, the plurality of spikes 104 being nonporous, superficially porous, or combinations thereof, and the pores 200 being radially oriented or randomly oriented are specifically included in the scope of the present embodiments. By way of non-limiting example, in one embodiment the core 102 is superficially porous including a nonporous central region 204 surrounded by a porous shell 206 having randomly oriented pores 200. In another embodiment, the core 102 is superficially porous including a nonporous central region 204 surrounded by a porous shell 206 having radially oriented pores 200.

Exemplary porous shells 206 that have a random pore orientation, a radial pore orientation, and a combination of radial and random pore orientation that may be used as the core particle of this invention are described in U.S. Patent Application Publication No. 2007/0189944, U.S. Pat. No. 8,685,283, and US Patent Application No. 2020/0338528, respectively, the contents of which are incorporated herein by references in their entirety. The porous shell 206 may be formed of any suitable material, including, but not limited to, silica, hybrid silica, alumina, titania, zirconia, or combinations thereof.

In embodiments in which either the core 102, the plurality of spikes 104, or both are superficially porous, the porous shell 206 may have any suitable shell thickness 208, including, but not limited a shell thickness 208 of about 1 nm to about 2 μm, alternatively about 5 nm to about 2 μm, alternatively about 5 nm to about 100 nm, alternatively about 50 nm to about 500 nm, alternatively about 250 nm to about 750 nm, alternatively about 500 nm to about 1 μm, alternatively about 750 nm to about 1.25 μm, alternatively about 1 μm to about 1.5 μm, alternatively about 1.25 μm to about 1.75 μm, alternatively about 1.5 μm to about 2 μm, or any sub-range or combination thereof. The porous shell 206 may constitute any suitable volume of the core 102 (when the core 102 is superficially porous) of the spike 104 (when the spike 104 is superficially porous), including, but not limited to, constituting, by volume, about 10% to about 90%, alternatively about 5% to about 70%, alternatively about 20% to about 70%, alternatively about 30% to about 60%, alternatively about 5% to about 15%, alternatively about 10% to about 20%, alternatively about 15% to about 25%, alternatively about 20% to about 30%, alternatively about 25% to about 35%, alternatively about 30% to about 40%, alternatively about 35% to about 45%, alternatively about 40% to about 50%, alternatively about 45% to about 55%, alternatively about 50% to about 60%, alternatively about 55% to about 65%, alternatively about 60% to about 70%, or any sub-range or combination thereof.

Each core 102 may have any suitable number of spikes 104, including, but not limited to, at least 2, alternatively at least 3, alternatively at least 4, alternatively at least 4, alternatively 2-50, alternatively 1-100, alternatively 2-10, alternatively 5-15, alternatively 10-20, alternatively 15-25, alternatively 20-30, alternatively 25-35, alternatively 30-40, alternatively 35-45, alternatively 40-50, or any suitable sub-range or combination thereof.

The plurality of spikes 104 may have any suitable average spike length 110 (measured along the spike 104), including, but not limited to, about 20 nm to about 20 μm, alternatively about 20 nm to about 100 nm, alternatively about 50 nm to about 500 nm, alternatively about 100 nm to about 1 μm, alternatively about 500 nm to about 2 μm, alternatively about 1 μm to about 10 μm, alternatively about 5 μm to about 15 μm, alternatively about 10 μm to about 20 μm, or any sub-range or combination thereof. The average spike length 110 distribution may be ±80% or less, alternately ±50% or less, alternately ±40% or less, alternately ±30% or less, alternately ±20% or less of the average spike length 110.

The plurality of spikes 104 may have any suitable average spike width 112 (measured orthogonal to the average spike length 110), including, but not limited to, about 50 nm to about 5 μm, alternatively from about 100 nm to about 3 μm, alternatively from about 300 nm to about 1 μm, alternatively from about 400 nm to about 1 μm, and alternatively from about 400 nm to about 700 nm, alternatively about 50 nm to about 250 nm, alternatively about 100 nm to about 500 nm, alternatively about 250 nm to about 1 μm, alternatively about 500 nm to about 1 μm, alternatively about 1 μm to about 3 μm, alternatively about 2 μm to about 5 μm, or any sub-range or combination thereof. The average spike width 112 distribution may be ±50% or less, alternately ±40% or less, alternately ±30% or less, alternately ±20% or less of the average spike width 112.

The spike particle 100 may have any suitable ratio of the average spike length 110 to the average core width 106, including, but not limited to, from about 0.2 to about 30, alternatively about 0.2 to about 10, alternatively about 5 to about 15, alternatively about 10 to about 20, alternatively about 15 to about 25, alternatively about 20 to about 30, or any sub-range or combination thereof.

The plurality of spikes 104 may have any suitable ratio of the average spike length 110 to the average spike width 112, including, but not limited to, from about 0.2 to about 50, alternatively about 0.2 to about 10, alternatively about 5 to about 15, alternatively about 10 to about 20, alternatively about 15 to about 25, alternatively about 20 to about 30, alternatively about 25 to about 35, alternatively about 30 to about 40, alternatively about 35 to about 45, alternatively about 40 to about 50, or any sub-range or combination thereof.

The core 102 may be formed of any suitable material, including, but not limited to, silica, hybrid silica, alumina, titania, zirconia, ferric oxide, hematite, zinc oxide, carbon, carbonized silica, diamond, silver, gold, polystyrene, poly(methyl methacrylate), or combinations thereof. Exemplary hybrid silicas are described in U.S. Pat. No. 8,778,453, the contents of which are incorporated herein by references in their entirety.

The plurality of spikes 104 may be formed of any suitable material, including, but not limited to, silica, hybrid silica, alumina, titania, zirconia, or combinations thereof.

The core 102 may have any suitable shape, including, but not limited to, a sphere, a spheroid, a polyhedron, a cube, a cuboid, a prism, a pyramid, a cylinder, a tube, a cone, a frustum, a disk, an annulus, a torus, or combinations thereof. The core 102 may have a continuous structure or may include a hollow center.

The plurality of spikes 104 may have any suitable cross-sectional shape (orthogonal to the average spike length 110), including, but not limited to, a circle, an ellipse, a polyhedron, a triangle, a quadrilateral, a rectangle, a square, pentagon, a hexagon, an irregular shape, or combinations thereof. The plurality of spikes 104 may have a continuous structure or may include a hollow center. The plurality of spikes 104 may be uniformly straight along the average spike length 110 or may taper along the average spike length 110 (Murphy et al., J. Colloid interface Sci., 501(2017), 45-53). During tapering of the spike 104, the spike width 112 may decrease gradually or abruptly. The plurality of spikes 104 may tail, decreasing gradually or abruptly in spike width 112 to a relatively long tail. The plurality of spikes 104 may be bended or curved. “Bended” indicates that a spike 104 has one twist from one end to the other. “Curved” indicates that a spike 104 has at least two twists from one end to the other. A terminus of a spike 104 may be open. A spike 104 may have a plurality of segments, which may have different spike widths 112 or material compositions or both.

The spike particles 100 may have any suitable specific surface area, including, but not limited to, a specific surface area ranging from about 5 cm²/g to about 1,000 cm²/g, alternatively from about 5 m²/g to about 500 m²/g, alternatively from about 20 m²/g to about 400 m²/g, alternatively from about 30 m²/g to about 300 m²/g, alternatively from about 50 m²/g to about 200 m²/g, alternatively 5 cm²/g to about 100 cm²/g, alternatively about 50 cm²/g to about 150 cm²/g, alternatively about 100 cm²/g to about 200 cm²/g, alternatively about 150 cm²/g to about 250 cm²/g, alternatively about 200 cm²/g to about 300 cm²/g, alternatively about 250 cm²/g to about 350 cm²/g, alternatively about 300 cm²/g to about 400 cm²/g, alternatively about 350 cm²/g to about 450 cm²/g, alternatively about 400 cm²/g to about 500 cm²/g, alternatively a specific surface area less than about 5 cm²/g, or any sub-range or combination thereof. In one embodiment, where in the spike particle 100 is porous, the spike particle 100 has a specific surface area ranging from about 20 m²/g to about 1000 m²/g, alternatively from about 30 m²/g to about 600 m²/g, alternatively from about 50 m²/g to about 500 m²/g, and alternatively from about 200 m²/g to about 400 m²/g.

The spike particles 100 may have any suitable specific pore volume, including, but not limited to, a specific pore volume ranging from about 0.05 cm³/g to about 1.5 cm³/g, alternatively about 0.05 cm³/g to about 1.00 cm³/g, alternatively from about 0.10 cm³/g to about 0.70 cm³/g, alternatively from about 0.20 cm³/g to about 0.50 cm³/g, and alternately from about 0.25 cm³/g to about 0.40 cm³/g, alternatively about 0.05 cm³/g to about 0.5 cm³/g, alternatively about 0.25 cm³/g to about 0.75 cm³/g, alternatively about 0.5 cm³/g to about 1 cm³/g, alternatively about 0.75 cm³/g to about 1.25 cm³/g, alternatively about 1 cm³/g to about 1.5 cm³/g, or any sub-range or combination thereof In one embodiment, where in the core 102 is porous, the core 102 has a specific pore volume ranging from about 0.10 cm³/g to about 1.50 cm³/g, alternatively from about 0.15 cm³/g to about 1.00 cm³/g, alternatively from about 0.20 cm³/g to about 0.90 cm³/g, alternately from about 0.30 cm³/g to about 0.80 cm³/g, alternately from about 0.30 cm³/g to about 0.70 cm³/g.

The spike particles 100 may have any suitable average pore diameter, including, but not limited to, an average pore diameter ranging from about 2 nm to about 100 nm, alternatively about 3 nm to about 100 nm, alternatively from about 6 nm to about 100 nm, alternatively from about 8 nm to about 50 nm, alternatively from about 10 nm to about 30 nm alternatively about 3 nm to 50 nm, alternatively about 25 nm to 75 nm, alternatively about 50 nm to 100 nm, or any sub-range or combination thereof. In one embodiment, wherein the core 102 is porous, the core 102 has an average pore diameter ranging from about 2 nm to about 100 nm, alternatively from about 6 nm to about 100 nm, alternatively from about 8 nm to about 50 nm, alternatively from about 8 nm to about 50 nm, alternatively from about 10 nm to about 30 nm.

In one embodiment, the core particles 102 have a narrow particle size distribution, varying by no more than 20%, alternatively 10%, alternatively 5%, or less of the average core width 106.

The spike particles 100 may have any suitable density, including, but not limited to, a density ranging from about 0.1 g/cm³ to about 5.0 g/cm³, alternatively about 0.2 g/cm³ to about 5.0 g/cm³, alternatively from about 0.3 g/cm³ to about 4.0 g/cm³, alternatively from about 0.4 g/cm³ to about 3.0 g/cm³, alternatively from about 0.5 g/cm³ to about 1.3 g/cm³, and alternatively from about 0.6 g/cm³ to about 1.2 g/cm³ alternatively about 0.1 g/cm³ to about 2.0 g/cm³, alternatively about 1.0 g/cm³ to about 3.0 g/cm³, alternatively about 2.0 g/cm³ to about 4.0 g/cm³, alternatively about 3.0 g/cm³ to about 5.0 g/cm³, or any sub-range or combination thereof. In one embodiment, wherein the core 102 is porous, the core 102 has a density ranging from about 0.20 g/cm³ to about 5.00 g/cm³, alternatively from about 0.30 g/cm³ to about 4.00 g/cm³, alternatively from about 0.40 g/cm³ to about 3.00 g/cm³, alternatively from about 0.40 g/cm³ to about 0.90 g/cm³, alternatively from about 0.40 g/cm³ to about 0.80 g/cm³.

In one embodiment, the spike particle 100 has a specific surface area ranging from about 5 cm²/g to about 500 cm²/g, a specific pore volume ranging from about 0.05 cm³/g to about 1.5 cm³/g, an average pore diameter ranging from about 3 nm to about 100 nm, and a density ranging from about 0.1 g/cm³ to about 5.0 g/cm³. In another embodiment, the spike particle 100 has a specific surface area less than about 5 cm²/g, a specific pore volume less than about 0.05 cm³/g, and a density ranging from about 1.0 g/cm³ to about 5.0 g/cm³, alternatively 1.5 g/cm³ to about 2.5 g/cm³.

In one embodiment, the spike particle 100 includes not more than 100 ppm sodium ions, alternatively not more than 90 ppm sodium ions, alternatively not more than 80 ppm sodium ions, alternatively not more than 70 ppm sodium ions, alternatively not more than 60 ppm sodium ions, alternatively not more than 50 ppm sodium ions, alternatively not more than 40 ppm sodium ions, alternatively not more than 30 ppm sodium ions, alternatively not more than 20 ppm sodium ions, alternatively not more than 10 ppm sodium ions, alternatively not more than 5 ppm sodium ions, alternatively not more than 1 ppm sodium ions, alternatively not more than 0.1 ppm sodium ions, alternatively is free of sodium ions.

In one embodiment, the spike particle 100 is substantially metal ion-free, having a content of metallic impurities other than silicon not more than 100 ppm, alternatively not more than 90 ppm, alternatively not more than 80 ppm, alternatively not more than 70 ppm, alternatively not more than 60 ppm, alternatively not more than 50 ppm, alternatively not more than 40 ppm, alternatively not more than 30 ppm, alternatively not more than 20 ppm, alternatively not more than 10 ppm, alternatively not more than 5 ppm, alternatively not more than 1 ppm, alternatively not more than 0.1 ppm, alternatively the spike particle 100 is free of metallic impurities other than silicon.

The plurality of spike 104 and the core 102 may have the same material composition or a different material composition. The plurality of spikes 104 may include different individual spikes 104 having different material compositions on the same core 102.

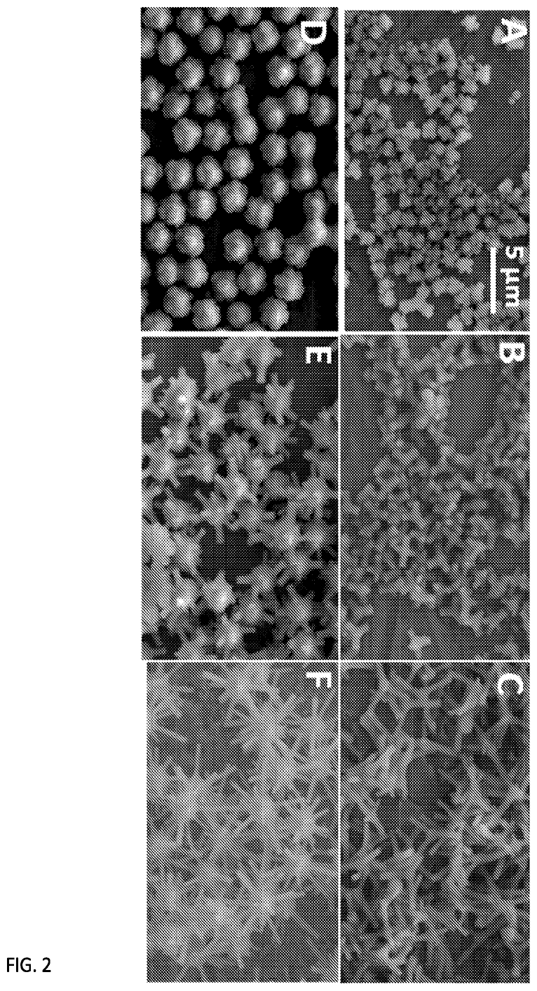

Referring to FIG. 2, SEM images of spike particles 100 illustrate the control of the average spike length 110, number of spikes 104, and average spike width 112. The average core widths 106 of panels A-C and D-F are 0.9 μm and 2.0 μm, respectively. The scale bar of 5 μm is applicable to all images.

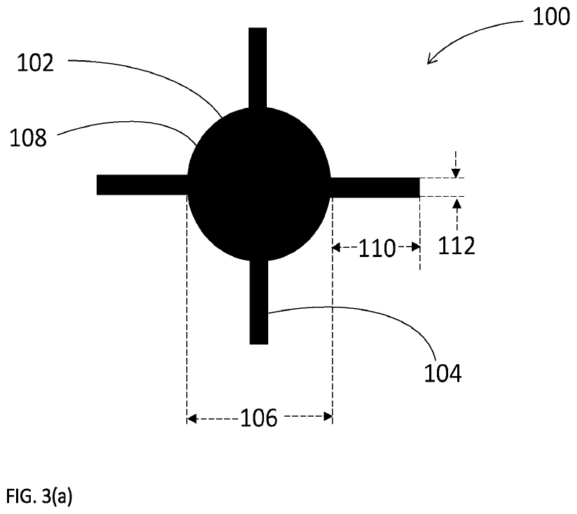

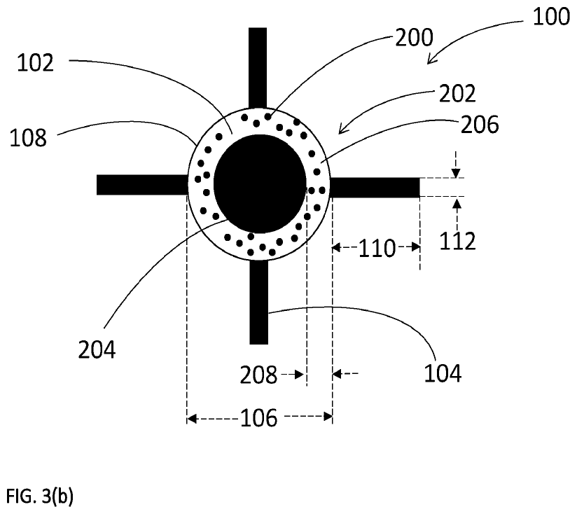

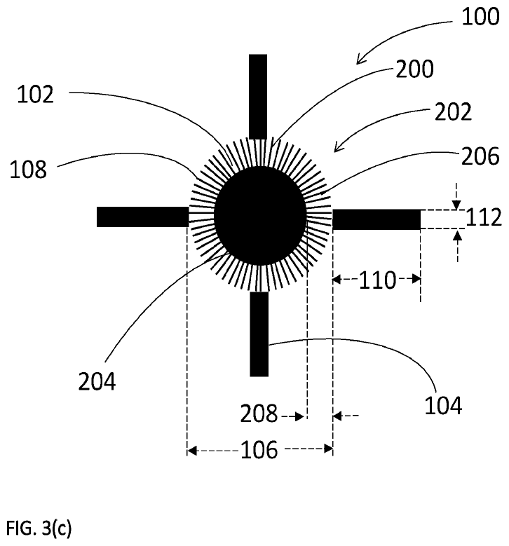

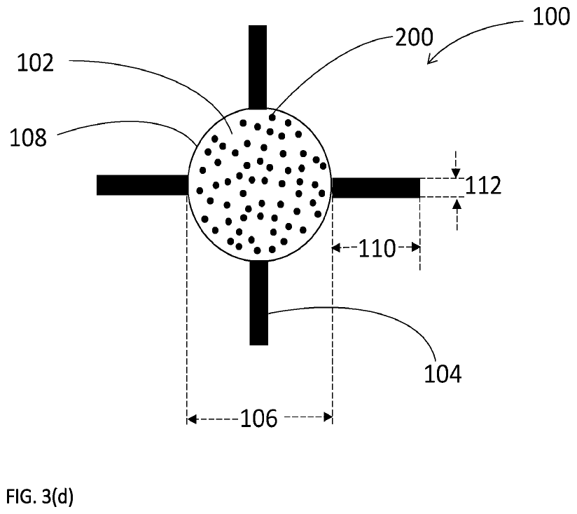

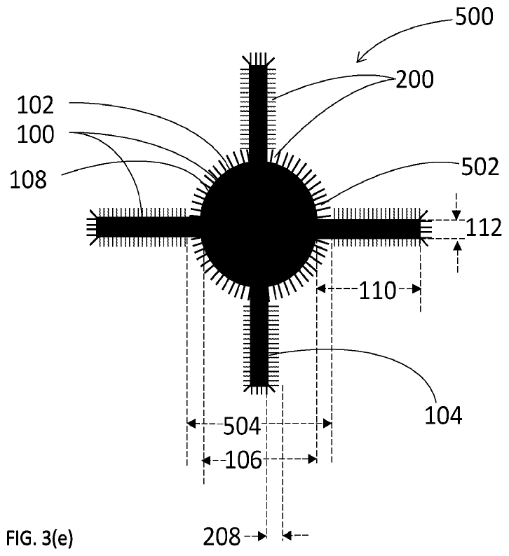

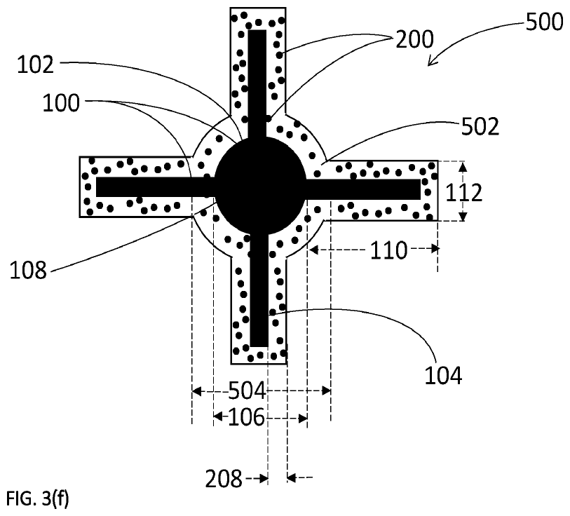

Referring to FIG. 3(a), in one embodiment the spike particle 100 has a nonporous core 102 and nonporous spikes 104.

Referring to FIG. 3(b), in one embodiment the spike particle 100 has a core 102 which is superficially porous and nonporous spikes 104. The superficially porous core 202 includes a nonporous central region 204 and a porous shell 206 surrounding the nonporous central region 204. The porous shell 206 includes randomly oriented pores 200.

Referring to FIG. 3(c), in one embodiment the spike particle 100 has a core 102 which is superficially porous and nonporous spikes 104. The superficially porous core 202 includes a nonporous central region 204 and a porous shell 206 surrounding the nonporous central region 204. The porous shell 206 includes radially oriented pores 200.

Referring to FIG. 3(d), in one embodiment the spike particle 100 has a porous core 102 with randomly oriented pores 200, and nonporous spikes 104.

Referring to FIGS. 3(e) and 3(f), a superficially porous spike particle 500 may include a spike particle 100 (as described above) having a nonporous core 102 and a plurality of nonporous spikes 104 over which a porous spike particle shell 502 is disposed. The porous spike particle shell 502 may have radially oriented pores 200 (FIG. 3(e)) or randomly oriented pores 200 (FIG. 3(f)). The porous spike particle shell 502 may be formed of any suitable material, including, but not limited to, silica, hybrid silica, or combinations there. The porous spike particle shell 502 may have any suitable shell thickness 208, any suitable specific pore volume, any suitable pore size, and any suitable average pore diameter, and may constitute any suitable volume of the superficially porous spike particle 500, as described above with respect to the porous shells 206 of the spike particles 100. The superficially porous spike particle 500 may include any suitable specific surface area, any suitable density, and any suitable dimensions as described above with respect to the spike particles 100.

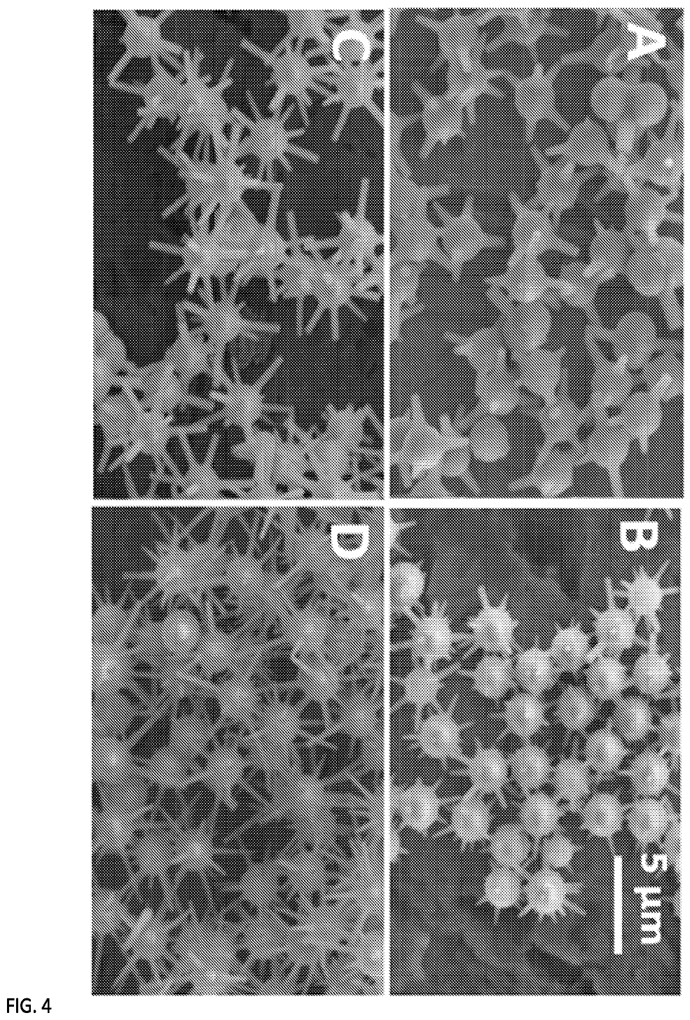

Referring to FIG. 4, SEM images of spike particles 100 prepared according to the processes in Examples 1-4 illustrate the control of the average spike length 110, number of spikes 104, and average spike width 112. The scale bar is 5 μm, applicable to all images.

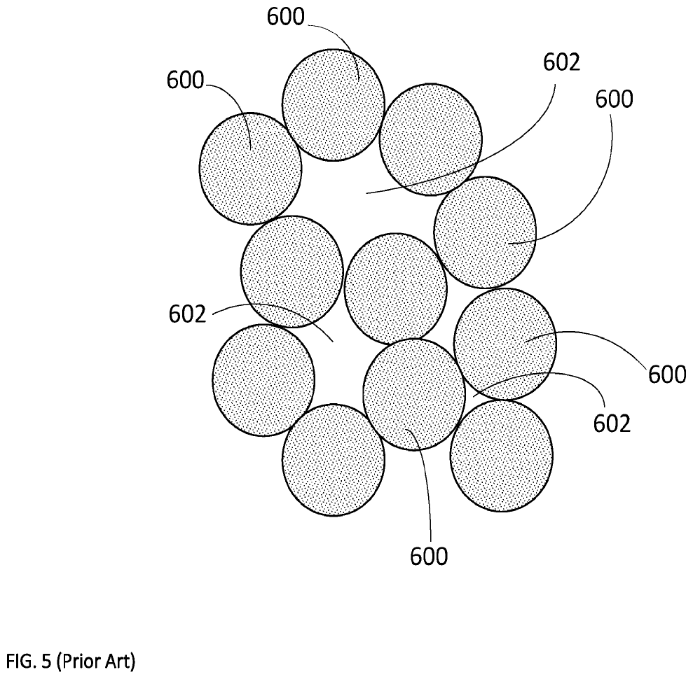

Referring to FIG. 5, a 2-dimentional cross-sectional representation of randomly packed spherical particles 600 represents the random packing of a commercially available HPLC column. The spherical particles 600 must be in physical contact with a certain number of their nearest neighbor counterparts to form a stable packed bed. This packing organization yields interstitial space voids 602, which are flow-through pores in the 3-dimentional packed bed. The total volume of all flow-through pores over the packed volume is the external porosity, which is fixed at approximately at 0.4 for columns packed with spherical particles regardless of the diameter of the spherical particles 600.

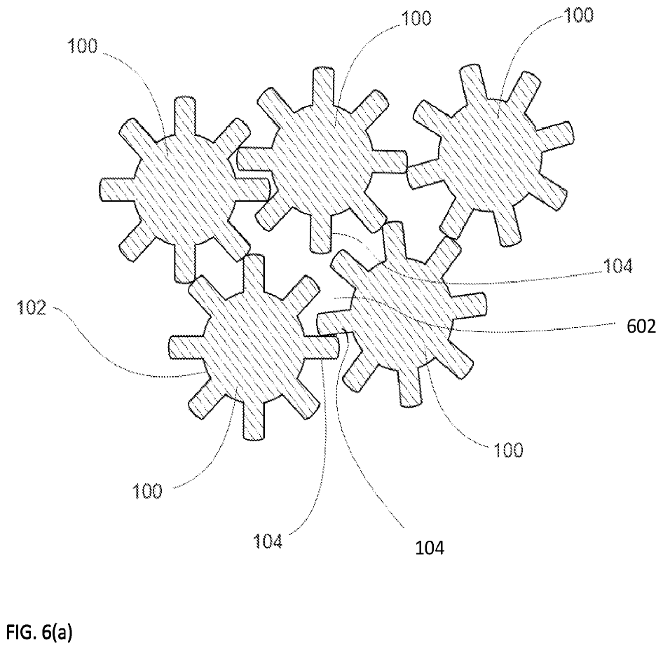

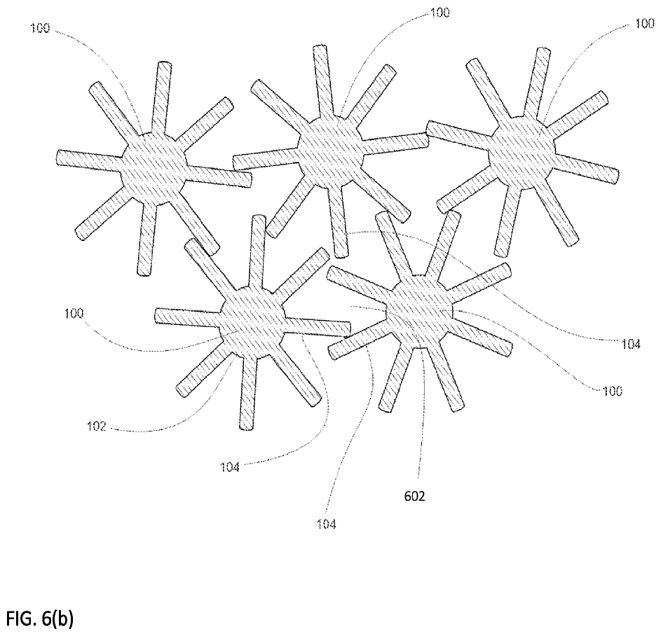

Referring to FIG. 6(a), a 2-dimentional cross-sectional representation of randomly packed spiked particles 100 having average spike lengths 110 roughly ⅓ of the average core widths 106 illustrates that cores 102 of the spike particles 100 does not contact each other. Packed bed stability is assured by various forms of spike-spike contact and spike-core contact. Spike particle 100 packing yields larger interstitial space voids 602 and higher external porosity than spherical particle 600 packing illustrated in FIG. 5.

Referring to FIG. 6(a), a 2-dimentional cross-sectional representation of randomly packed spiked particles 100 particles having average spike lengths 110 roughly equal to the average core widths 106 illustrates that for spike particles 100 having longer relative average spike lengths 110, the interstitial space 602 is greater as compared to the packing illustrated in FIG. 6(a).

In one embodiment, a chromatographic separation device includes a plurality of spike particles 100, wherein the plurality of spike particles 100 are randomly packed in the chromatographic separation device. The plurality of spike particles 100 as randomly packed may have any suitable external porosity, including, but not limited to, an external porosity ranging from about 0.4 to about 0.9, alternatively about 0.4 to about 0.6, alternatively about 0.5 to about 0.7, alternatively about 0.6 to about 0.8, alternatively about 0.7 to about 0.9, or any sub-range or combination thereof.

The chromatographic separation device may have readily adjustable and increased fluid permeability relative to a comparative chromatographic separation device having a plurality of otherwise identical spherical particles lacking the plurality of spikes 104 in lieu of the plurality of spike particles 100.

The chromatographic separation device may be any vessel that contains a randomly packed bed of spike particles 100, including, but not limited to, a chromatograph column, a microfluidic channel, a filter disk, a solid phase separation cartridge, a petite tip, a centrifuge tube, a 96-well plate, or combinations thereof.

FIG. 5 illustrates a 2-dimentional cross-sectional representation of randomly packed spherical particles 600. This particle organization represents the random packing of a commercially available HPLC column. The spherical particles 600 must be in physical contact with a certain number of their nearest neighbor counterparts to form a stable packed bed. This packing organization yields interstitial space 602, which are flow-through pores in the 3-dimentional packed bed. The total volume of all flow-through pores is the external porosity. Columns packed with spherical particles 600 have a nearly fixed value of external porosity at 0.4, independent of the particle diameter. There is little flexibility to increase column permeability and thus reduce backpressure in spherical particle 600-based columns by increase external porosity. Backpressure in these columns is inversely to the square of the diameter of the particle. In practice, this does not allow columns packed with particles smaller than 1.5 μm to be operated at optimized flow rates (highest efficiency) in state of the art UHPLC instrument without exceeding pressure limits. Referring to FIGS. 6(a) and 6(b), which illustrates 2-dimentional cross-sectional representations of randomly packed spiked particles 100, the core 102 of the spike particles 100 do not contact each other. There are, however, various forms of contacts including spike tip-spike tip, spike tip-core, spike tip-spike body, spike body-spike body, and spike-spike-spike. In addition, they are multiple spikes 104 on each spike particle 100. Therefore, the average contact number between spike particles 100 may be much higher than between spherical particles 600. As such, a packed bed of spike particles 100 may be stable even though it has a larger interstitial spaces 602 and higher external porosity. Accordingly, columns packed with spike particles 100 may have a higher permeability and lower backpressure than columns packed with spherical particles 600. By changing the average spike length 110, the external porosity of the packing bed may be readily adjusted. In addition, the number of spikes 104 and the average spike width 112 may also be used to adjust the external porosity. Higher number of spikes 104 and smaller average spike widths 112 lead to higher external porosity. Referring to FIG. 2 and FIG. 4, the length, number, and to some degree, the width of spikes 104 may be easily controlled.

In both monolithic columns and columns packed with spherical particles 600, high efficiency and high permeability are inherently incompatible. High permeability is correlated with large feature sizes of the packed beds including large flow-through pores and large particle diameter or monolithic skeleton. While not being bound by theory, it is believed that large feature sizes cause an increase of various band dispersions and thus reduce column efficiency. Columns packed with spike particles 100 may have both small features (thus high efficiency) and high permeability. First, under the same permeability conditions, the diameter of the core 102 and spike 104 of the spike particles 100 is smaller than that of the spherical particle 600. Second, referring FIGS. 6(a) and 6(b), the interstitial space 602 (a flow-through pore in 3-dimension) always house a certain number of spikes 104. These spikes 104 in the flow-through pores may make a larger flow-through pore acting like a few smaller flow-through pores. In addition, these spikes 104 may act as a role of radial mixing to reduce analyte diffusion in the flow-through pore. Therefore, even though columns packed with spike particles 100 have a relatively high external porosity (high permeability), their feature sizes of the solid zone (core 102 and spike 104) and mobile zone (effective flow-through pore) may be relatively small. Accordingly, columns packed with spike particles 100 may have a relatively loose relationship between efficiency and permeability compared to columns packed with spherical particles 600 and monolithic columns.

In one embodiment, a process for forming a plurality of spike particles 100 includes mixing a continuous oil phase and a dispersed aqueous phase to form a water-in-oil emulsion system, wherein the continuous oil phase includes an organic solvent, polyvinylpyrrolidone, and a silane precursor, and the dispersed aqueous phase includes a plurality of core particles 102, a water emulsion drop stabilizer, and a catalyst. The water-in-oil emulsion system is reacted without stirring to form the plurality of spike particles 100. The plurality of spike particles are separated from the water-in-oil emulsion system.

Suitable organic solvents include, but are not limited to, alcohols with a formula CₙH₂ₙ₊₁OH, wherein n is an integer from 5 to 10, such as 1-pentanol.

The polyvinylpyrrolidone may have any suitable molecular weight, including, but not limited to, an average molecular weight of at least about 10 KDa, alternatively at least 30 KDa, alternatively at least 50 KDa, alternatively at least 130 KDa, alternatively about 10 KDa to about 130 KDa, alternatively about 10 KDa to about 30 KDa alternatively about 20 KDa to about 40 KDa alternatively about 30 KDa to about 50 KDa alternatively about 40 KDa to about 60 KDa alternatively about 50 KDa to about 70 KDa alternatively about 60 KDa to about 80 KDa alternatively about 70 KDa to about 90 KDa alternatively about 80 KDa to about 100 KDa alternatively about 90 KDa to about 110 KDa alternatively about 100 KDa to about 120 KDa alternatively about 110 KDa to about 130 KDa, or any sub-range or combination thereof.

The silica precursor may be any suitable precursor, including, but not limited to, tetramethoxysilane, tetraethyl orthosilicate (“TEOS”), tetrapropoxysilane, tetrabutoxysilane, prehydrolyzed derivations thereof, silicate oligomers, or combinations thereof.

The catalyst may include any suitable species, including, but not limited to, urea, basic amino acids, quaternary ammonium hydroxides, organic amines (primary, secondary or tertiary), ammonium hydroxide, ammonium fluoride, and ammonium hydrogen difluoride, or combinations thereof.

The dispersed aqueous phase may further include a water emulsion drop stabilizer. Suitable water emulsion drop stabilizers include, but are not limited to, organic ammonium citrate salt, ammonium tartrate dibasic, ammonium acid urate, ammonium oxalate, ammonium citrate dibasic, di-ammonium hydrogen citrate, ammonium citrate tribasic, malic acid, lactic acid, uric acid, tartaric acid, oxalic acid, citric acid, and citric acid monohydrate, or combinations thereof.

The reaction temperature may range from about 0° C. to about 70° C. Temperature manipulates the average spike width 112. The average spike width 112 typically decreases with the increase of temperature. However, high temperature may lead to the increase of rods not attached to the core particles 102 and not-straight spikes 104. The reaction time may range from about 1 hour to about 7 days. The average spike length 110 increases with the reaction time up to a few days. However, manipulating the average spike length 110 may be particularly effective in the first 15 hours of the reaction.

In one embodiment, the organic solvent, the polyvinylpyrrolidone, the core particles 102, and the catalyst are mixed for a mixing duration of from about 1 minute to about 2 days prior to the silane precursor being added.

The continuous oil phase and the dispersed aqueous phase may further include a co-solvent which has a substantial solubility in both the continuous oil phase and the dispersed aqueous phase. Suitable co-solvents include, but are not limited to, acetone, acetonitrile, tetrahydrofuran, one or more alcohols with a formula CₙH₂ₙ₊₁OH, n being an integer from 1 to 4, such as ethanol and isopropanol, or combinations thereof.

The cores 102 may be surface-modified. The surface modifier may be covalently bonded or physically adsorbed to the core 102. The surface modifier may increase the hydrophilicity and uniformity of the core 102 and may cover the pores 200 in case the core 102 is porous or superficially porous, allowing water drops to better and more evenly attach the core 102. Examples of suitable surface modifiers are various hydrophilic polymers, which may include, but are not limited to, polyvinylpyrrolidone, polyvinyl alcohol, polyethylene glycols, polyelectrolytes such as poly(diallydimethylammonium) chloride, water soluble cellulose derivatives, gelatin, and starch. Polyvinylpyrrolidone may be used as a surface modifier advantageously because it is hydrophilic and non-toxic, strongly absorbed on the silica surface, and has the same composition as the polyvinylpyrrolidone in the continuous phase. Polyvinylpyrrolidone may aid in stabilizing the water droplets. Polyvinylpyrrolidone used as a surface modifier may have the same or different molecular weight as the polyvinylpyrrolidone used in the continuous phase.

Separating the plurality of spike particles 100 from the water-in-oil emulsion system may include at least one of centrifugation or filtration.

Organic residue may be removed from the plurality of spike particles 100 by any suitable technique, including, but not limited to, calcination.

The surfaces of the plurality of spike particles may be rehydrolyzed by etching. Procedures available for silica rehydroxylation may be found in U.S. Pat. No. 4,874,518, incorporated herein in its entirety by reference.

In a further process, the spike particles 100 may be disposed in a bi-phase mixture comprising an aqueous bottom phase and an organic top phase, the aqueous bottom phase including the spike particles 100, a template, and a catalyst, and the organic top phase including a top phase organic solvent and a top phase silane precursor, and heating the bi-phase mixture under reflux conditions to form superficially porous spike particles 500 each having a porous spike particle shell 502 disposed on the spike particle 100. Suitable top phase organic solvents include, but are not limited to, cyclohexane. Suitable templates include, but are not limited to, cetyltrimethylammonium bromide. The top phase silica precursor may be any suitable precursor, including, but not limited to, tetramethoxysilane, tetraethyl orthosilicate (“TEOS”), tetrapropoxysilane, tetrabutoxysilane, or combinations thereof.

In one embodiment, based on 100 parts by weight of pentanol, (a) polyvinylpyrrolidone has an average molecular weight of about 40 KDa and is dissolved in pentanol, about 5 to 20 parts by weight of polyvinylpyrrolidone; (b) the co-solvent is ethanol, about 0 to 20 parts by weight of ethanol; (c) the water content is a sum of all water including those in NH3, citrate, and the core particle, about 3-15 parts by weight of water; (d) the water drop stabilizer is ammonium citrate dibasic, which is dissolved in water, about 0.5-3 parts by weight of ammonium citrate dibasic; (e) the catalyst is 28% ammonium hydroxide, about 0.3-5 parts by weight of 28% ammonium hydroxide; (f) the silane precursor is TEOS, about 0.05-5 parts by weight of TEOS; (g) the core 102 is spherical nonporous, superficially porous, or porous silica with its diameter ranging from about 0.5 to about 5 μm; (h) the core surface 108 is modified by polyvinylpyrrolidone with a molecular weight of about 40 KD; (i) the core 102 or surfaced modified core is dispersed in water; about 0.05-5 parts by weight of the core 102; (j) the order of chemical mixing is pentanol-polyvinylpyrrolidone, silica core particle 102, water, ammonium citrate dibasic, ammonium hydroxide, and the TEOS; (k) after adding each chemical, the mixture is undergone agitation used methods such as shaking, stirring, sonication, vortex and the like for about 10 seconds to about 10 minutes; (1) before adding TEOS, the water-in-oil emulsion mixture is resting without agitation for about 1 minute to 2 days (m) the reaction occurs without any agitation; (n) the reaction temperature ranges from about 0° C. to about 70° C.; and (o) the reaction time ranges from about 2 hours to 2 days. The spike particles 100 prepared by the foregoing method are separated from the emulsion system (including by centrifugation or filtration, or both) and may be rinsed with any suitable rinsing fluid, such as, but not limited to, water, ethanol, acetone, or combinations thereof. Repeated rinsings may be utilized, including, but not limited to, anywhere from 1 to 10 times. The separated spike particles 100 may then subject to a calcination step, a solvent extraction step, or both, to substantially remove organic residues. Calcination may be carried out at a higher temperature, at least 550° C., alternatively at least 650° C., alternatively at least 750° C., alternatively at least 850° C. In addition to removing organic residues, two other changes are well known during calcination. First, the silanol groups (Si—OH) on the silica surface are gradually dehydrated and transformed into siloxane group bond (Si—O—Si). Second, the silica skeleton is gradually densified, leading to a decrease of surface area and pore volume and an increase in mechanical strength. A rehydrolization step may be added to restore the surface silanol concentration. In certain cases, a silica layer may form simultaneously with the spikes 104 on the cores 102 that block pores 200 on the core surface 108. This layer may be removed by etching the spike particles 100 in diluted ammonium hydroxide, HF, or ammonium fluoride. Removing the silica layer may be done either before or after the organic resides are removed.

In one embodiment, superficially porous spike particles 500 may be formed by forming a porous layer on spike particles 100. Methods such as those disclosed in U.S. Pat. No. 8,685,283 may be suitable for the preparation of superficially porous spike particles 500 with radially oriented pores 200 (FIG. 3(e)), incorporated herein in its entirety by reference. Likewise, methods such as those disclosed in U.S. Pat. No. 8,864,988 and U.S. Pat. Application Publication No. 2007/0189944A1 may be suitable for the preparation of superficially porous spike particles 500 with randomly oriented pores 200 (FIG. 3(f)), incorporated herein in their entirety by reference.

In one embodiment, superficially porous spike particles 500 are prepared by a layer-by-layer bi-phase method including the steps of: (a): mixing an aqueous bottom phase and an organic top phase for a mixing duration to form a bi-phase mixture; (b) heating the bi-phase mixture under reflux conditions for a refluxing duration to form superficially porous spike particles 500; (c) separating superficially porous spike particles 500 from the bi-phase mixture by centrifugation or filtration; (d) optionally repeating steps (a)-(b) until a desired shell thickness 208 of the porous spike particle shell 502 is reached; (e) optionally removing organic residues from superficially porous spike particles 500 by calcination or solvent extraction; (f) optionally increasing the pore size and removing smaller mesopores less than 5 nm from the superficially porous spike particles 500 by hydrothermal treatment or basic etching; (g) optionally increasing the mechanical strength of superficially porous spike particles 500 by hydrothermal treatment or sintering at a temperature up to 975° C.; (h) optionally activating the surface of superficially porous spike particles 500 by hydrothermal treatment or basic etching; and (i) optionally modifying the surface of the superficially porous spike particles 500 with a functional group. The aqueous bottom phase may include a plurality of spike particles 100, a template such as cetyltrimethylammonium bromide, and a catalyst such as urea. The organic top phase may include an organic solvent such as cyclohexane and a silane precursor such as TEOS. A co-solvent, which is soluble in both phases, such as isopropanol, may be added. The reaction may be carried out at 70° C. for about 24 hours. Step (c), separating the as-prepared superficially porous spike particles 500 from the bi-phase mixture, may be achieved by any suitable method such as centrifugation, filtration, or combinations thereof. The superficially porous spike particles 500 may be rinsed with rinsing fluids such as water, ethanol, acetone, or combinations thereof. Typical rinsing processes include 1-10 rinse repetitions. Step (e), removing organic residues in the superficially porous spike particles 500, may be carried out by calcination at a temperature of about 600° C. for about 12 hours. Alternatively, organic residues may be removed by solvent extraction, as described by Yue et al. in J. Am. Chem. Soc., 137 (2015), 13282-13289, incorporated herein in its entirety by reference. Step (f), increasing the pore size and removing smaller mesopore less than 5 nm spike particles 500, may be performed by hydrothermal treatment, as described in WO 2010/061367, incorporated herein in its entirety by reference. Alternatively, etching by ammonium bifluoride may be effective to change the porosity of superficially porous spike particles 500, a process described in European Pat. No. 0272904B1, incorporated herein in its entirety by reference. Etching may also be performed at room temperature or under reflux conditions in an aqueous slurry that contain one or more than one etching chemicals selected from a group of urea, basic amino acids, quaternary ammonium hydroxides, organic amines (primary, secondary, or tertiary), ammonium hydroxide, or ammonium fluoride. Step (g), sintering, may be used to densify the skeleton and increase the mechanical strength of superficially porous spike particles 500. Sintering may be carried out at very high temperature such as between about 900° C. to about 975° C. Temperature above 975° C. may induce the porous network of the superficially porous spike particles 500 to collapse, and further treatment, such as rehydroxylation, may be very difficult. The sintered superficially porous spike particles 500 may have sufficient structural strength to resist a packing pressure of 20,000 psi. Nevertheless, these superficially porous spike particles 500 may be hydrophobic due to a very low concertation of Si—OH groups. As such, they may not be very useful as packing materials for chromatographic applications without further treatment such as rehydroxylation. Step (h), rehydroxylation, may be performed under conditions similar to the etching process or hydrothermal treatment described in step (f). Exemplary processes of rehydroxylation are disclosed in U.S. Pat. No. 4,874,518, incorporated herein in its entirety by reference. Step (i), surface modification of the superficially porous spike particles 500 may include modification to have surface functional groups. Suitable functionalized surface groups include, but are not limited to, alkyl groups, alkynl groups, aryl groups, diol groups, amino groups, alcohol groups, amide groups, cyno groups, ether groups, nitro groups, carbonyl groups, epoxide groups, sulfonyl groups, cation exchanger groups, anion exchanger groups, carbamate groups, urea groups, dimethyloctyl groups, dimethyloctadecyl groups, methyldiphylsilyl groups, or combinations thereof. Exemplary processes of surface modification may be found in Lork et. al., J. Chromatogr., 352 (1986), 199-211), incorporated herein in its entirety by reference.

### EXAMPLES

In the following examples, the average core widths 106 were measured by the Beckman Coulter Counter technique. The average spike length 110, number of spikes 104 per core 102, average spike width 112, and average core width 106 of the spike particles 100 were estimated from the scanning electron microscope (SEM) images. Porosity, including specific surface area, pore size, and specific pore volume of superficially porous spike particles 500, were measured by nitrogen sorption analysis.

Materials: Polyvinylpyrrolidone 40K and polyvinylpyrrolidone 55K, ammonium citrate dibasic (ACS reagent, 98%), ethanol (200 proof), 1-pentanol (REAGENTPLUS®, >99%), ammonium hydroxide (ACS reagent, 28%), TEOS (reagent grade, 98%), cyclohexane, cetyltrimethylammonium bromide (>98%), urea (ACS reagent, >99%), acetone (ACS reagent, >99%), isopropanol (ACS reagent, >99%), ammonium fluoride (reagent grade, 98%), and ammonium bifluoride (reagent grade, 98%) were purchased from Sigma Aldrich.

Polyvinylpyrrolidone 40K or polyvinylpyrrolidone 55K stock solution was prepared by dissolving 100 g of polyvinylpyrrolidone in 1 L of 1-pentnaol. 0.27 M of ammonium citrate dibasic solution was prepared by dissolving 3.06 g of ammonium citrate dibasic in 50 mL of water. Silica core particles 102<1 μm were prepared by the Stober method (Stober et al., J. Colloid and Interface Sci., 26 (1968), 62-69). Silica core particles 102 of ˜2 μm width were synthesized by the method disclosed in U.S. Pat. No. 4,775,520 using silica particles<1 μm as the seed. The 15% stock solution of surface modified core particles 102 was prepared by adding 15 g of the core particles 102 in 100 mL of water containing 7.5 g of polyvinylpyrrolidone 40K or polyvinylpyrrolidone 55K. The 5% stock solution of surface modified core particles 102 was prepared by adding 5 g of the core particles 102 in 100 mL of water containing 5 g of polyvinylpyrrolidone 40K or polyvinylpyrrolidone 55K.

The following examples are related to the preparation of spike particles 100.

### Example 1

In a 1,000 mL glass bottle, 21.40 mL of surface modified core particles 102 (2.10 μm, 15% stock solution) was added in 800 mL 1-pentanol-polyvinylpyrrolidone 55K stock solution and the mixture was sonicated for 5 minutes followed by the addition of 1.80 mL of water, 4.80 mL of 0.27 M ammonium citrate dibasic, and 16.00 mL of 28% ammonium hydroxide. The resultant mixture was sonicated for 2 minutes and then shaken by hand for 2 minutes to form a water/1-pentanol emulsion. Subsequently, the above mixture was left to rest for approximately 30 minutes. Then, 20.00 mL of TEOS was quickly added into the above mixture. After further shaking for approximately for 2 minutes by hand, the resultant mixture was left to rest and allowed to react for approximately 48 hours. The resultant mixture was then centrifuged, resuspended in water one time, and in 90% water/10% ethanol (v/v) two times to collect the spike particles 100. After drying at 100° C. and calcinating at 600° C. to remove organic residues, approximately 3.3 g of spike particles 100 were obtained. FIG. 4 panel A is an SEM image of the spike particles 100. The average number of spikes 104, average spike length 110, and average spike width 112 of the spike particles 100 are estimated to about 6, 1 μm, and 0.5 μm, respectively.

### Example 2

In a 1,000 mL glass bottle, 22.47 mL of surface modified core particles 102 (2.10 μmm 15% stock solution) was added in 840 mL 1-pentanol-polyvinylpyrrolidone 55K stock solution and the mixture was sonicated for 5 minutes followed by the addition of 1.80 mL of water, 5.04 mL of 0.27 M ammonium citrate dibasic, and 16.80 mL of 28% ammonium hydroxide. The resultant mixture was sonicated for 2 minutes and then shaken by hand for 2 minutes to form a water/1-pentanol emulsion. Subsequently, the above mixture was left to rest for approximately 20 minutes. Then, 21.00 mL of TEOS was quickly added into the above mixture. After further shaking for approximately for 2 minutes by hand, the resultant mixture was left to rest and allowed to react for approximately 48 hours. The resultant mixture was then centrifuged, resuspended in water one time, and in 90% water/10% ethanol (v/v) two times to collect the spike particles 100. After drying at 100° C. and calcinating at 600° C. to remove organic residues, approximately 3.5 g of spike particles 100 were obtained. FIG. 4 panel B is an SEM of the spike particles 100. The average number of spikes 104, average spike length 110, and average spike width 112 of spike particles 100 are estimated to about 15, 0.8 μm, and 0.4 μm, respectively. The spike particles 100 of this example have a relatively broad distribution of spike length 110.

### Example 3

In a 1,000 mL glass bottle, 20.0 mL of surface modified core particles 102 (2.1 μm, 15% stock solution) was added in 762 mL 1-pentanol-polyvinylpyrrolidone 55K stock solution and the mixture was sonicated for 2 minutes followed by the addition of 1.68 mL of water, 4.57 mL of 0.27 M ammonium citrate dibasic, and 14.95 mL of 28% ammonium hydroxide. The resultant mixture was sonicated for 2 minutes and then shaken by hand for 2 minutes to form a water/1-pentanol emulsion. Subsequently, the above mixture was left to rest for approximately 20 minutes. Then, 19 mL of TEOS was quickly added into the above mixture. After further shaking for approximately for 2 minutes by hand, the resultant mixture was left to rest and allowed to react for approximately 48 hours. The resultant mixture was then centrifuged, resuspended in water one time, and in 90% water/10% ethanol (v/v) two times to collect the spike particles 100. After drying at 100° C. and calcinating at 600° C. to remove organic residues, approximately 3.0 g of spike particles 100 were obtained. FIG. 4 panel C is an SEM of the spike particles. The average number of spikes 104, average spike length 110, and average spike width 112 of spike particles 100 are estimated to be about 15, 1.5 μm, and 0.5 μm, respectively.

### Example 4

In a 1,000 mL glass bottle, 22.50 mL of surface modified core particles 102 (2.20 μm, 15% stock solution) was added in 843 mL 1-pentanol-polyvinylpyrrolidone 55K stock solution and the mixture was sonicated for 5 minutes followed by the addition of 1.90 mL of water, 5.06 mL of 0.27 M ammonium citrate dibasic, and 21.60 mL of 28% ammonium hydroxide. The resultant mixture was sonicated for 2 minutes and then shaken by hand for 2 minutes to form a water/1-pentanol emulsion. Subsequently, the above mixture was left to rest for approximately 30 minutes. Then, 21.60 mL of TEOS was quickly added into the above mixture. After further shaking for approximately for 2 minutes by hand, the resultant mixture was left to rest and allowed to react for approximately 48 hours. The resultant mixture was then centrifuged, resuspended in water one time, and in 90% water/10% ethanol (v/v) two times to collect the spike particles 100. After drying at 100° C. and calcinating at 600° C. to remove organic residues, approximately 4.0 g of spike particles 100 were obtained. FIG. 4 panel D is an SEM image of the spike particles 100. The average number of spikes 104, average spike length 110, and average spike width 112 of spike particles 100 are about more than 20, 2 μm, and 0.4 μm, respectively. The spike particles 100 of this example have a relatively broad distribution of spike length 110.

### Example 5

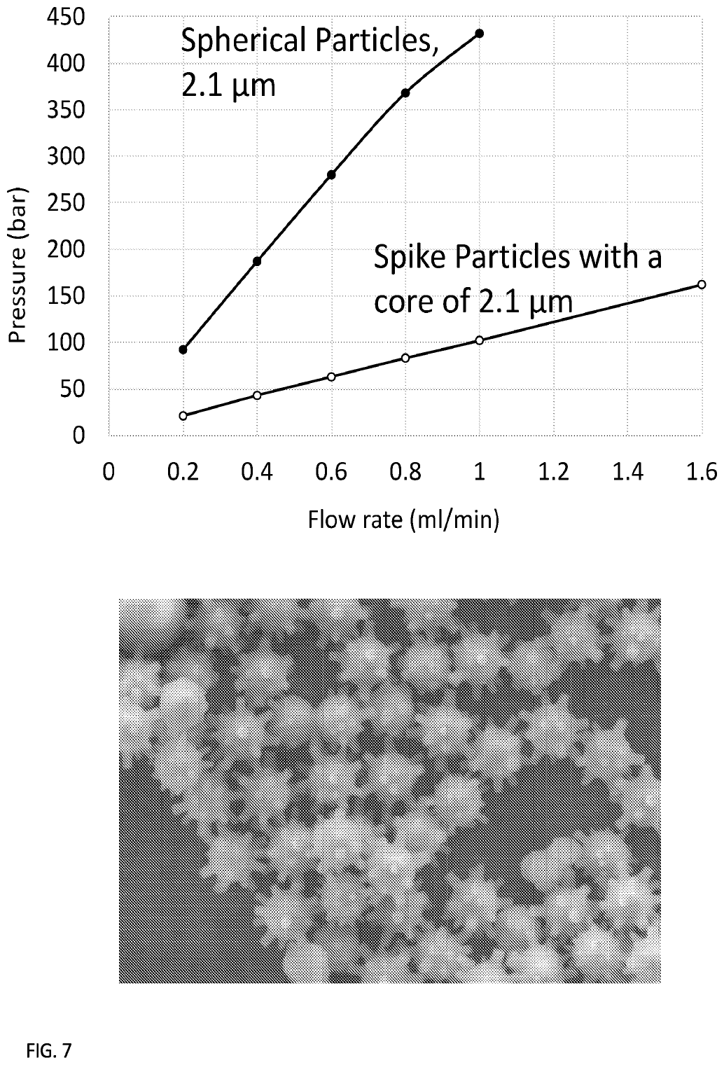

In a 1,000 mL glass bottle, 12 mL of polyvinylpyrrolidone 40K surface modified core particles 102 (2.1 μm, 5% stock solution) was added in 500 mL of 1-pentanol-PVP 40 stock solution and the mixture was sonicated for 2 minutes followed by the addition of 3 mL of 0.27 M ammonium citrate dibasic, and 10 mL of 28% ammonium hydroxide, 12.5 mL of ethanol, and 1 mL of water. The resultant mixture was shaken by hand for approximately 2 minutes to form a water/n-pentanol emulsion. Subsequently, the above mixture was left to rest for approximately 30 minutes. Then, 10 mL of TEOS was quickly added into the above mixture. After further shaking for approximately for 2 minutes by hand, the resultant mixture was left to rest and allowed to react for approximately 72 hours without stirring. The resultant mixture was then centrifuged, resuspended in water one time, and in 90% water/10% ethanol (v/v) two times to collect the spike particles 100. After drying at 100° C. and calcinating at 600° C. to remove the organic residues, approximately 0.6 g of spike particles 100 were obtained. FIG. 7 includes an SEM image of the spike particles 100. The average number of spikes 104, average spike length 110, and average spike width 112 of spike particles 100 are estimated to be about 20, 0.8 μm, and 0.5 μm, respectively.

The spike particles 100 were packed into a 2.1×50 mm column by the slurry method to evaluate the column backpressure. Slurry packing is well documented in the literature. Its general guidelines may be found in a publication titled “Fundamental and Practical Insights on the Packing of Modern High-Efficiency Analytical and Capillary Columns” (Wahab et al., Anal. Chem. 89 (2017), 8177-8191), incorporated herein in its entirety by reference.

FIG. 7 shows column back pressure versus flow rate data obtained with columns (2.1×50 mm) packed with spike particles 100 prepared according to the process of Example 5 as compared to spherical particles 600 having a diameter equal to the core width of spike particles 100 (2.1 μm). The accompanying SEM image shows the structure of the spike particles 100. The mobile phase is a 60/40 (V/V) water/acetonitrile mixture. FIG. 7 illustrates that backcrosse of columns packed with spike particles 100 is about 4 times lower than that of column packed with spherical particles 600.

### Example 6

### Related to the Preparation of Spike Particles 100 and Superficially Porous Spike Particles 500

Preparation of spike particles 100 with a nonporous core 102 and nonporous spikes 104 attached on the core surface 108 (see FIG. 3(a)): In an 1,000 mL glass bottle, 10.7 mL of polyvinylpyrrolidone 40K surface modified core particles 102 (2.1 μm, 15% stock solution) was added in 400 mL of 1-pentanol-polyvinylpyrrolidone 40K stock solution and the mixture was sonicated for 2 minutes followed by the addition of 2.4 mL of 0.27 M ammonium citrate dibasic, and 8.0 mL of 28% ammonium hydroxide. The resultant mixture was shaken by hand for approximately 2 minutes to form a water/n-pentanol emulsion. Subsequently, the above mixture was left to rest for approximately 30 minutes. Then, 10.3 mL of TEOS was quickly added into the above mixture. After further shaking for approximately for 2 minutes by hand, the resultant mixture was left to rest and allowed to react for approximately 72 hours. The resultant mixture was then centrifuged, resuspended in water one time, and in 90% water/10% ethanol (v/v) two times to collect the spike particles 100. After drying at 100° C. and calcinating at 600° C. to remove organic residues, 1.55 g of spike particles 100 were obtained. The calcined spike particles 100 were rehydrolyzed in 0.15 mL of 28% ammonium hydroxide and 15 mL of water for 2 hours. The rehydrolyzed spike particles 100 were then collected by centrifugation.

Preparation of superficially porous spikes 500 with the above spike particles 100 and a porous spike particle shell 502 having a radially oriented pores 200, (see FIG. 3(e)): A layer-by-layer process disclosed in US Patent Application Publication No. 2020/0338528 was used to prepare superficially porous spike particles 500. 1.5 g of rehydrolyzed spike particles 100 were mixed with 50 mL water that also contained 1.5 g of cetyltrimethylammonium bromide and 0.90 g urea in a three neck 250 mL flask. The mixture was sonicated approximately 10 minutes to dissolve the cetyltrimethylammonium bromide and urea and fully disperse the spike particles 100. Subsequently, 50 mL of cyclohexane and 1.5 mL of isopropanol were added to the aqueous mixture to form a bi-phase system. After magnetic stirring the mixture at 130 rpm/min for 30 min, 1.20 mL of TEOS was slowly added to the top cyclohexane phase while increasing the reaction temperature from 25° C. to 77° C. in about 20 minutes. The mixture was allowed to react for 48 hours under reflux conditions. The resultant product was then collected by centrifugation was referred as superficially porous spike particles-L1 500 and suspended in 10 mL of water.

To prepare the porous spike particle shell 502, 1.5 g cetyltrimethylammonium bromide and 0.90 g urea were added together into 40 mL water in a three neck 250 mL flask, which was sonicated approximately 5 minutes. Superficially porous spike particles-L1 500 were then transferred into the cetyltrimethylammonium bromide, urea, and water mixture, which was sonicated approximately 5 minutes. Subsequently, 50 mL of cyclohexane and 1.5 mL of isopropanol were added to the above aqueous mixture to form the bi-phase system. After magnetic stirring the mixture at 130 rpm/min for 30 min, 1.20 mL TEOS was slowly added to the top cyclohexane phase while increasing the reaction temperature from 25° C. to 77° C. in about 20 minutes. The mixture was allowed to react for 48 hours under reflux conditions. The product was then centrifuged, resuspended in water one time, and in 50% water/50% ethanol (v/v) two times. The product was dried at 100° C. and calcined at 550° C. to remove organic residues.

The calcined superficially porous spike particles 500 were etched in 30 mL of water containing 0.65 g of ammonium fluoride for 12 hours to modify their pore size. The surface modified superficially porous spike particles 500 were then sintered at 900° C. for 10 hours to increase their mechanical strength. The sintered superficially porous spike particles 500 were then rehydroxylated in 15 mL of water containing 0.13 g of ammonium bifluoride for 2 hours to increase their surface Si—OH concentration.

The specific surface area, average pore size, and specific pore volume of the superficially porous spike particles 500 determined by nitrogen sorption analysis were 111 m²/g, 8.5 nm, and 0.27 cc/g, respectively. The average shell thickness 208 of the superficially porous spike particles 500 was estimated from SEM images of spike particles 100 and superficially porous spike particles 500. The average shell thickness 208 is half of the shelled width 504 of the core 102 with the porous spike particle shell 502 disposed thereon less the width 106 of core particle 102 of the spike particle 100, which is about 0.25 μm.

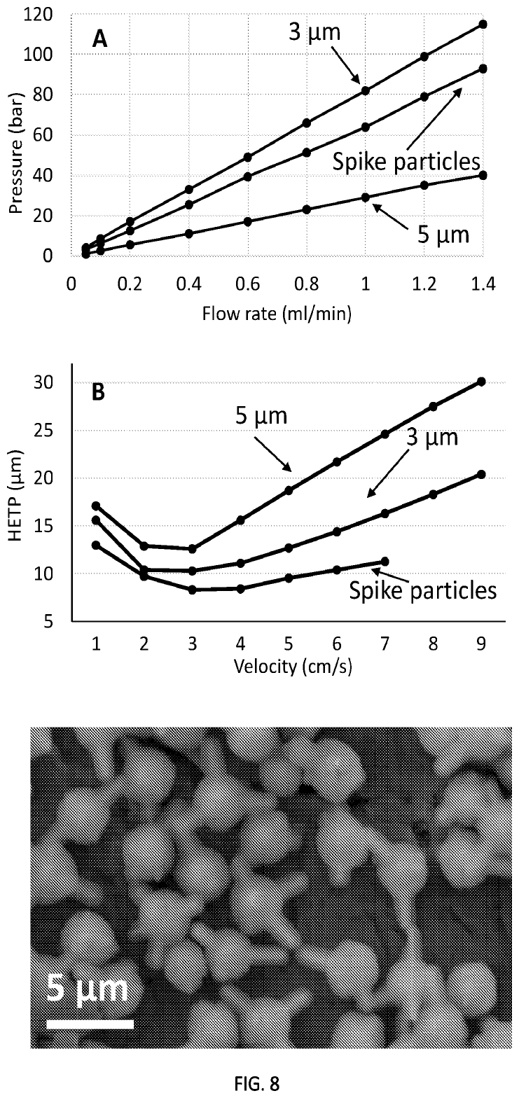

FIG. 8 compare chromatographic data obtained with columns packed with superficially porous spike particles 500 prepared according to the process in Example 6 as compared to columns packed with totally porous spherical particles 600 of 3 μm and 5 μm. Panel A is back pressure versus mobile phase flow rate and panel B is HETP (height equivalent to a theoretical plate) versus mobile phase velocity. Panel C is an SEM image of the superficially porous spike particles 500. The columns (2.1×50 mm) were tested with an Agilent 1260 series chromatograph equipped with quaternary pump, autosampler, thermostatted column compartment, and a 5 μL flow cell variable wavelength detector using cytosine as solute. The mobile phase is 97% water/3% acetonitrile/10 mM Ammonium formate for superficially porous spike particles 500 and 95% water/5% acetonitrile/10 mM Ammonium formate for 3 μm and 5 μm spherical particles 600. The slight change of mobile phase is to adjust the retention time to a similar value for fair comparison of the column efficiency. The plots show that superficially porous spike particles 500 outperform porous spherical particles in terms of separation efficiency (smaller HETP) while the backpressure of the superficially porous spike particles 500 is between those of the 3 μm and 5 μm spherical particles. These results demonstrate that superficially porous spike particles 500 have superior performance for chromatographic separations with both higher efficiency and lower backpressure (higher permeability) than 3 μm spherical particles.

While the foregoing specification illustrates and describes exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A spike particle, comprising:
a core having an average core width and a core surface; and
a plurality of spikes attached to the core surface, the plurality of spikes extending an average spike length from the core surface and having an average spike width measured orthogonal to the average spike length;
wherein:
the spike particle is a chromatographic particle having not more than 100 ppm sodium ions;
the core includes a porosity selected from the group consisting of nonporous, superficially porous, porous, and combinations thereof; and
the plurality of spikes include a porosity selected from the group consisting of nonporous, superficially porous, and combinations thereof.

2. The spike particle of claim 1, wherein the core is superficially porous, including a porous shell having randomly oriented pores.

3. The spike particle of claim 1, wherein the core is superficially porous, including a porous shell having radially oriented pores.

4. The spike particle of claim 1, wherein the core is superficially porous, including a porous shell thickness of about 5 nm to about 2 μm.

5. The spike particle of claim 1, wherein the core is superficially porous, including a porous shell constituting about 5% to about 70% by volume of the core.

6. The spike particle of claim 1, wherein a ratio of the average spike length to the average core width ranges from about 0.2 to about 30.

7. The spike particle of claim 1, wherein an aspect ratio of the average spike length to the average spike width ranges from about 0.2 to about 50.

8. The spike particle of claim 1, wherein the core is formed from a material including silica, hybrid silica, alumina, titania, zirconia, ferric oxide, hematite, zinc oxide, carbon, carbonized silica, diamond, silver, gold, polystyrene, poly(methyl methacrylate), or combinations thereof.

9. The spike particle of claim 8, wherein the core and the plurality of spikes are formed from silica.

10. The spike particle of claim 1, wherein the plurality of spikes are formed from a material including silica, hybrid silica, alumina, titania, zirconia, or combinations thereof.

11. The spike particle of claim 1, wherein the core has a shape selected from the group consisting of a sphere, a spheroid, a polyhedron, a cube, a cuboid, a prism, a pyramid, a cylinder, a tube, a cone, a frustum, a disk, an annulus, a torus, and combinations thereof.

12. The spike particle of claim 1, wherein the plurality of spikes number at least four.

13. The spike particle of claim 1, wherein the average spike length ranges from about 20 nm to about 20 μm.

14. The spike particle of claim 1, wherein the average spike width ranges from about 50 nm to about 5 μm.

15. The spike particle of claim 1, having a specific surface area ranging from about 5 cm²/g to about 500 cm²/g, a specific pore volume ranging from about 0.05 cm³/g to about 1.5 cm³/g, an average pore diameter ranging from about 3 nm to about 100 nm, and a density ranging from about 0.1 g/cm³ to about 5.0 g/cm³.

16. The spike particle of claim 1, having a specific surface area less than about 5 cm²/g, a specific pore volume less than about 0.05 cm³/g, and a density ranging from about 1.5 g/cm³ to about 2.5 g/cm³.

17. The spike particle of claim 1, wherein the spike particle is substantially metal ion-free, having a content of metallic impurities other than silicon not more than 100 ppm.

18. A superficially porous spike particle, comprising:
a core having an average core width and a core surface, the core being non-porous;
a plurality of spikes attached to the core surface, the plurality of spikes being nonporous and extending an average spike length from the core surface and having an average spike width measured orthogonal to the average spike length; and
a porous spike particle shell disposed on the core and the plurality of spikes,
wherein the spike particle is a chromatographic particle having not more than 100 ppm sodium ions.

19. A chromatographic separation device, comprising a plurality of spike particles, each of the plurality of spike particles including:
a core having an average core width and a core surface; and
a plurality of spikes attached to the core surface, the plurality of spikes extending an average spike length from the core surface and an average spike width measured orthogonal to the average spike length;
wherein:
each of the plurality of spike particles is a chromatographic particle;
the core includes a porosity selected from the group consisting of nonporous, superficially porous, porous, and combinations thereof;
the plurality of spikes include a porosity selected from the group consisting of nonporous, superficially porous, and combinations thereof;
the plurality of spike particles are randomly packed in the chromatographic separation device;
the plurality of spike particles as randomly packed have an external porosity ranging from about 0.4 to about 0.9; and
the chromatographic separation device has increased fluid permeability relative to a comparative chromatographic separation device having a plurality of otherwise identical spherical particles lacking the plurality of spikes in lieu of the plurality of spike particles.

20. The chromatographic separation device of claim 19, wherein the chromatographic separation device is a chromatograph column.

21-40. (canceled)
